(19) United States
(12) Patent Application Publication
(10) Pub. No.: US 2008/0034926 A1
(43) Pub. Date: Feb. 14, 2008

(54) Bi-directional pawl-less wrench

(76) Inventor: Peter C. Chaconas, Glyndon, MD (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/501,939

(22) Filed: Aug. 10, 2006

(51) Int. Cl. B25B 13/00; B25B 13/46

(52) U.S. Cl. 81/58.4; 81/60; 81/125

(57) ABSTRACT

A wrench has a handle integral with a ratchet head that defines a chamber having a generally circular sidewall. An annular rotor has radial teeth about an outer surface thereof and is located in the chamber. The rotor teeth engage a single set of teeth extending radially inward from the chamber sidewall. Preferably, the sidewall teeth will be configured to have substantially equal height. Additionally, the two sides of each sidewall tooth that engage the rotor teeth will be configured to be substantially parallel.

### BACKGROUND OF THE INVENTION

The present invention relates generally to the art of hand tools, more particularly to a bi-directional wrench which operates without the use of a pawl.

Many types of wrenches have been provided over the years. Wrenches with ratcheting mechanisms are well known to those in the art. The ratchet mechanism in these wrenches permits the wrench to transmit torque in one rotational direction but allows free movement in the other rotational direction. As a result, a user is able to operate the wrench efficiently without removing the wrench from the nut or other driven component each time it is to be indexed. In some cases, ratchet heads may be mounted at both ends of the wrench, and in others a ratchet head will be mounted at one end of the wrench handle with an open box end provided at the other end.

Generally speaking, ratchet wrenches utilize a pawl having teeth that engage a rotatable gear (or ratchet wheel). The gear is retained within an opening located in the head of the wrench. The ratchet wheel may define a configured opening to directly engage a nut or to receive a particular insert tool. In other cases, the ratchet wheel may carry a tang for use with a variety of different sized sockets.

Ratchet wrenches that function without the use of pawls are known in the art. For example, U.S. Pat. No. 5,842,391 to Chaconas, incorporated herein by reference, discloses such a wrench. While many existing pawl-less wrenches exist, there exists room in the art for additional novel constructions.

### SUMMARY OF THE INVENTION

The present invention recognizes and addresses the foregoing disadvantages, and others, of prior art constructions and methods.

The present invention provides a wrench having a handle integral with a ratchet head. The ratchet head defines a chamber having a generally circular sidewall. An annular rotor having radial teeth about an outer surface thereof is located in the chamber. The rotor teeth engage a single set of teeth extending radially inward from the sidewall of the chamber. Preferably, the sidewall teeth will be configured to have substantially equal height. Additionally, the two sides of each sidewall tooth that engage the rotor teeth will be configured to be substantially parallel.

Other objects, features and aspects of the present invention are provided by various combinations and subcombinations of the disclosed elements, as well as methods of utilizing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a perspective view of a wrench in accordance with an embodiment of the present invention;

FIG. 2 is a perspective view of the opposite side of the wrench shown in FIG. 1;

FIG. 3 is a bottom plan view of the wrench shown in FIG. 1 with the rotor removed;

FIG. 4 is a perspective view of a rotor in accordance with an embodiment of the present invention;

FIG. 5 is side elevation cut-away view of the rotor shown in FIG. 4;

FIG. 6 is a cut-away perspective view of the wrench shown in FIG. 1 through line 6-6;

FIG. 7 is a bottom plan view of the wrench shown in FIG. 1 with the washer removed;

FIG. 8 is a bottom plan view of the wrench shown in FIG. 1 with the rotor teeth indexing over the bore teeth;

FIG. 9 is a perspective view of a wrench in accordance with an embodiment of the present invention;

FIG. 10 is an exploded view showing components of the wrench in accordance with an embodiment of the present invention.

FIG. 11 is a bottom plan view of the wrench shown in FIG. 9 with the rotor removed;

FIG. 12 is a perspective view of a rotor in accordance with an embodiment of the present invention;

FIG. 13 is side elevation cut-away view of the rotor shown in FIG. 11;

FIG. 14 is a cut-away perspective view of the wrench shown in FIG. 9 through line 7-7;

FIG. 15 is a bottom plan view of the wrench shown in FIG. 9 with the washer removed; and

FIG. 16 is a bottom plan view of the wrench shown in FIG. 9 with the rotor teeth indexing over the bore teeth.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

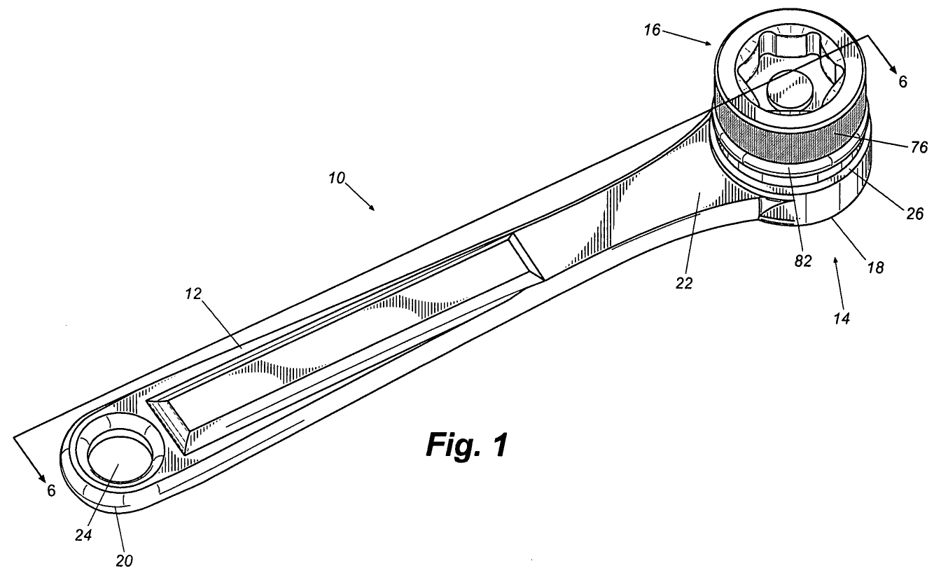

Referring to the drawings, and particularly to FIGS. 1, 2 and 3, a wrench 10 is shown having a handle 12, a head 14 and a rotor 16. The body and rotor may be formed from any suitable material, for example one or a combination of steel, alloy, ceramics, polymers, etc. A first end 18 defines head 14, and a second end 20 defines handle 12. Head 14 is integrally formed with handle 12 by a neck 22, and second end 20 has a bore 24 formed therethrough that allows for easy storage of wrench 10 when not in use. Instead of bore 24, other means of storing wrench 10 may be provided. One skilled in the art will also recognize that as an alternative to bore 24, a wrench head could be provided at second end 20.

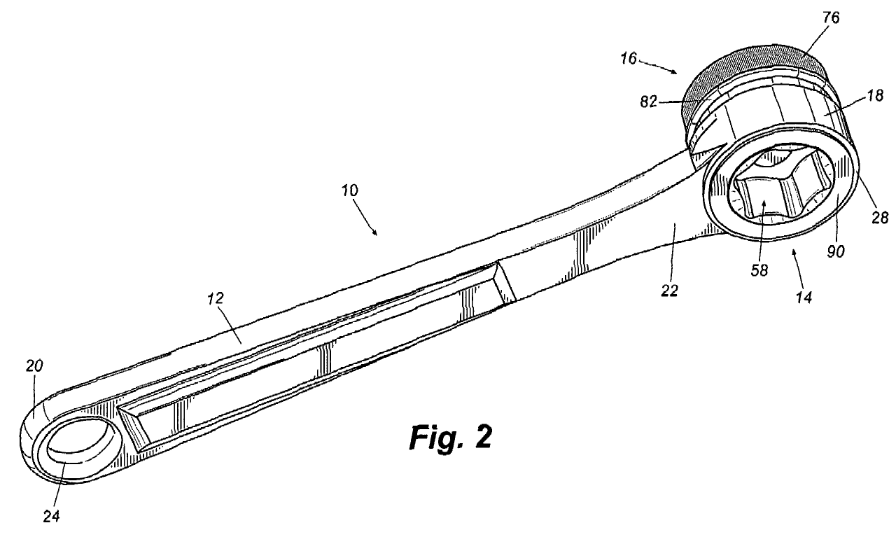

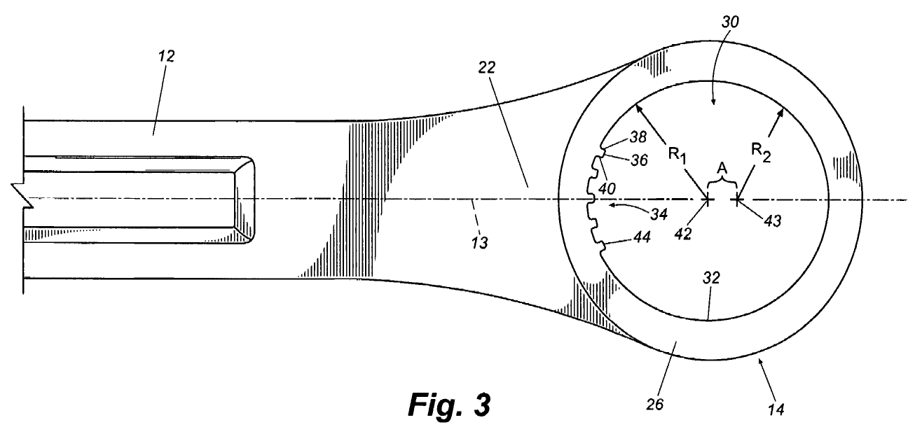

Head 14 has a top surface 26 (FIG. 1) and a bottom surface 28 (FIG. 2) located on opposite lateral sides of the wrench. Referring particularly to FIG. 3, head 14 defines a bore 30 that (1) extends between top surface 26 and bottom surface 28 and (2) is bounded by an inner circumferential surface 32. Bore 30 is an oval shape with a single axis of reflection symmetry about a longitudinal axis 13. The oval shape of bore 30 is generally defined by a first and a second arc located at either end of the oval, both of which are symmetric about longitudinal axis 13. The first and second arcs are defined by a radius R1 and R2 wherein R1 is substantially equal to R2. A center 42 of the first arc and center 43 of the second arc are offset along longitudinal axis 13 by a distance A. In the preferred embodiment offset distance A is 0.050 inches, R1 is 0.548 inches, and R2 is 0.548 inches.

A series of bore teeth 34 are formed on a portion of inner circumferential surface 32. With reference to a first bore tooth 36, each bore tooth has a first surface 38 and a second surface 40 that are substantially parallel to a plane that bisects first bore tooth 36 and intersects first arc center 42. In one preferred embodiment, first surface 38 and second surface 40 are substantially symmetric about a longitudinal center axis of first square-shaped bore tooth 36. In one preferred embodiment, bore teeth 34 each have a width of 0.041 inches with 0.066 inches of spacing between adjacent teeth. In some embodiments, first surface 38 and second surface 40 are symmetrical about a longitudinal center axis of the tooth yet angled slightly inward such that the base of the tooth is wider than the tip of the tooth thereby creating a trapezoid-shaped tooth.

Still referring to FIG. 3, bore teeth 34 are arranged sequentially on inner circumferential surface 32 from first tooth 36 to a last tooth 44. These teeth are of substantially equal height and shape and positioned on bore 30 such that bore teeth 34 are symmetric about longitudinal axis 13. In one preferred embodiment, five bore teeth each with a height of 0.030 inches are located on the surface of bore 30 adjacent to neck 22 with the centermost tooth bisected by longitudinal axis 13. U.S. Pat. No. 5,842,391 to Chaconas discloses examples of pawless wrenches that have the head bore teeth located at different positions within the bore and is incorporated by reference herein in its entirety. While the present invention may also include embodiments having only a single bore tooth, a plurality of bore teeth increases the torque loading of the wrench. In order to withstand the sheer forces associated with torquing a workpiece, the height of the bore tooth is preferably 75% of the width of the bore tooth.

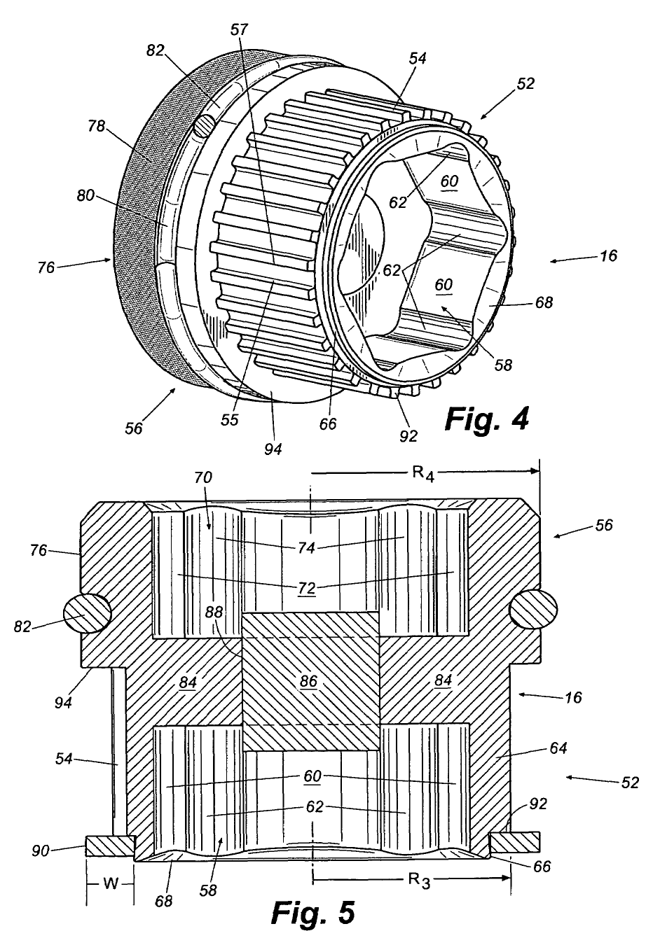

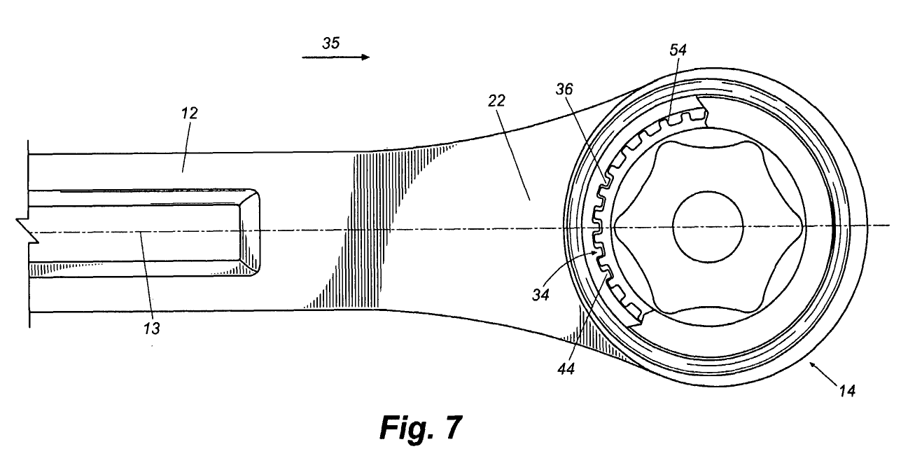

Referring to FIGS. 4 and 5, rotor 16 has a first portion 52 defined over a third radius R3 and a second portion 56 defined over a fourth radius R4 that is larger than radius R3. First portion 52 has rotor teeth 54 that are axially aligned with the rotor's centerline on the rotor's outer circumferential surface that are configured to interengage with bore teeth 34. Each rotor tooth has a first surface 55 that extends generally parallel to the plane that bisect the rotor tooth and intersects the center of rotor 16. Each rotor tooth as has a second surface 57 that extends generally parallel to the plane that bisect the rotor tooth and intersects the center of rotor 16 such that first surface 55 and second surface 57 are substantially parallel. In some embodiments, first surface 55 and second surface 57 are angled slightly inward such that the base of the tooth is wider than the tip of the tooth thereby creating a trapezoid-shaped tooth. The shape and size of rotor teeth 54 closely resemble the shape and size of bore teeth 34 such that bore teeth 34 interengage with rotor teeth 54, as shown in FIG. 7.

First portion 52 further defines a first cavity 58 therein that is configured to engage a workpiece. In the embodiment shown in FIG. 4, first cavity 58 has a hexagonally shaped cross-section and is formed from a series of substantially planar surfaces 60 separated by curved portions 62, which prevent the rounding of workpiece corners during torquing. A wall 64 is included between first cavity 58 and the first portion outer circumference and is sized to maintain proper strength qualities for a desired application. Referring specifically to FIG. 5, a lip 66 is formed about the outer edge of first portion 52 adjacent an edge 92 of rotor teeth 54. A tapered portion 68 facilitates positioning of first cavity 58 on a workpiece (not shown). In other embodiments, first cavity 58 can be configured to receive an open socket or other tool for performing a desired function. Still further embodiments are contemplated in which rotor 16 does not have a central opening, but instead carries a tang for receipt in a conventional socket.

Second portion 56 further defines a second cavity 70 that also is hexagonally shaped and formed from a series of substantially planar surfaces 72 separated by curved portions 74. While first cavity 58 and second cavity 70 could be configured to engage different-sized workpieces, in the embodiment shown in the figures, the cavities are sized to engage a similarly-sized workpiece.

Second portion 56 includes a flange 76 having a frictional outer edge surface 78 (FIG. 4). The flange may be formed from any number of materials, and may be a ring press-fitted to the outer circumference of second portion 56 or may be integrally formed with the rotor. Frictional outer edge surface 78 in the Figures is shown as a knurled surface designed to facilitate a user's rotation of rotor 16 by hand. Other suitable frictional surfaces, such as an elastomeric surface, could be used instead of the knurled surface. Flange 76 is also referred to as a “speed ring” because it allows a user to quickly spin rotor 16 without moving handle 12. Use of the speed ring is particularly advantageous once a threaded workpiece has been broken loose and only a low amount of torque is necessary to rotate the workpiece, such as during the removal of an oil drain plug. The same would be true when the workpiece is initially threaded during installation of the workpiece. Thus, while the amount of torque the user is able to impart to a workpiece is reduced when using flange 76, a higher number of rotations of rotor 16 may be accomplished in a shorter time. Second portion 56 also includes a groove 80 (FIG. 4) that receives an O-ring 82. O-ring 82 is preferably formed of an elastomer or other polymeric material and may be made in different colors to assist in the identification of different size wrenches.

Still referring to FIG. 5, rotor 16 includes a web 84 between first cavity 58 and second cavity 70. A bore 88 formed through web 84 receives a magnet 86 that retains a workpiece, such as an oil drain plug, within one or both of the cavities. Magnet 86 may be of any suitable shape material, and in one embodiment, magnet 86 is generally cylindrical in shape, formed from rare earth material and is press-fitted into bore 88. It should be understood that magnet 86 may be formed from two magnets one mounted in first cavity 58 and the other mounted in second cavity 70 proximate web 84, and may also be formed from other suitable materials, such as ferrite.

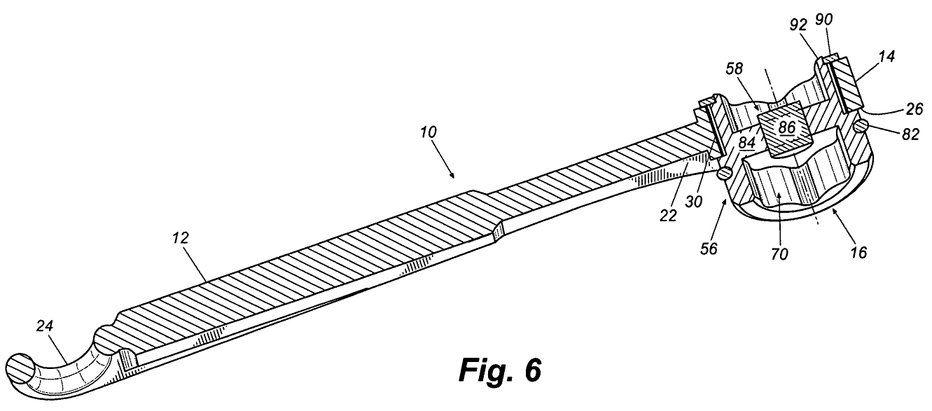

Referring to FIG. 6, rotor 16 is partially received within head bore 30. Bore radii R1 and R2 (FIG. 3) are substantially equal to radius R3. Since first arc center 42 and second arc center 43 are offset by distance A, rotor 16 can translate along longitudinal axis 13 by a distance substantially equal to distance A. Distance A is greater than the tooth height of rotor teeth 54 and bore teeth 34. Thus, when the rotor is translated away from the bore teeth there is sufficient free play between rotor 16 and inner circumferential surface 32 to allow the rotor teeth 54 to index over bore teeth 34 while not under torque loading.

Referring again to FIG. 5, a circular washer 90, having a width W, abuts rotor teeth end 92 and surrounds lip 66 (FIG. 6). Washer width W is selected so that the washer substantially seals the interior of bore 30 from the outside, thereby preventing debris from interfering with the operation of the rotor and bore teeth. In the embodiment shown in FIGS. 2 and 6, the outer diameter of washer 90 is approximately equal to second rotor portion radius R4. Once first portion 52 is inserted into head bore 30, and washer 90 is fitted about lip 66, a circular staking operation is performed upon lip 66 to secure washer 90 on rotor 16 and against bottom surface 28 so that the rotor is secured within head bore 30. When the rotor is installed in the head bore, a shoulder 94 (FIG. 4 and 5) abuts head top surface 26. Since radius R4 is larger than radius R3, rotor second portion 56 is sufficiently large to cover the opening created by head bore 30. Otherwise, debris could enter between first portion 52 and head bore 30, thereby negatively affecting the performance of the wrench.

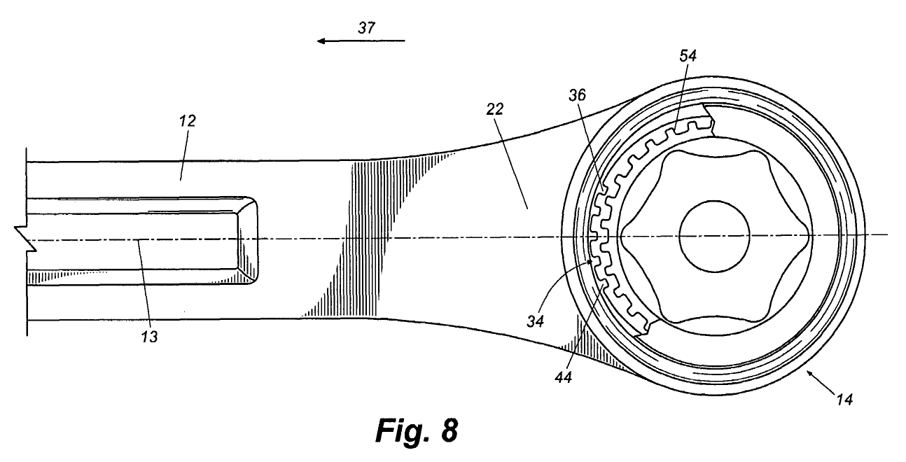

The operation of wrench 10 will now be described with reference to FIGS. 7 and 8. Referring first to FIG. 7, with rotor cavity 58 mounted on a workpiece, application of force to wrench 10 in the first direction 35 causes translation of rotor 16 relative to bore 30 along longitudinal axis 13. This translation engages rotor teeth 54 with head bore teeth 34. In this position, clockwise or counterclockwise rotation of handle 12 causes the rotor teeth 54 to contact bore teeth 34. Thus, as the wrench is rotated clockwise or counterclockwise, the load applied by handle 12 will be distributed over the surface area of contact between the bore and rotor teeth, thereby imparting rotation to the workpiece in the clockwise or counterclockwise direction. Once a full swing of handle 12 is reached, the handle is rotated in the opposite direction so that rotor teeth 54 pass over bore teeth 34, as described below.

Referring now to FIG. 8, generally cylindrical rotor 16 is shown in an indexing position wherein application of force to wrench 10 in the second direction 37 causes translation of rotor 16 relative to bore 30 along longitudinal axis 13 thereby disengaging rotor teeth 54 from bore teeth 34. That is, as handle 12 is rotated in either a clockwise or counterclockwise, neither bore teeth surfaces 38 or 40 bear against rotor teeth surfaces 55 or 57 so that the rotor can index in the opposite direction to that which torque is being applied. This indexing effect allows the head to rotate with respect to the rotor.

To loosen or tighten a workpiece (assuming the workpiece is right hand threaded), the user orients the wrench such that rotor cavity 58 (FIG. 6) receives the workpiece. In this position, cavity 58 engages the workpiece and the user can apply force in first direction 35 to wrench 10. Due to the oval shape of bore 30, such application of force causes translation of rotor 16 within bore 30. This translation is substantially similar to distance A. The translation of rotor 16 causes rotor teeth 54 to engage bore teeth 34. The spacing between adjacent rotor teeth is larger than the spacing between adjacent bore teeth which serves to ease interengagement of rotor teeth 54 and bore teeth 34. Additionally, the spacing helps to avoid binding of the rotor during operation. Once the rotor and bore teeth are interengaged, rotor teeth 54 and the bore teeth 34 remain in contact as rotational torque is applied to the workpiece in the clockwise or counterclockwise direction without the need for continuous application of force in first direction 35. As a clockwise or counterclockwise direction force is applied to handle 12 that force is translated through bore teeth 34 to rotor 16 be way of rotor teeth 54. If rotating handle 12 in a clockwise direction, side 38 (FIG. 3) of each bore tooth applies force to the engaged rotor teeth. If rotating handle 12 in a counterclockwise direction, side 40 (FIG. 40) of each bore tooth applies force to the engaged rotor teeth. This force applied to the engaged rotor teeth, and therefore upon rotor 16, is then translated to the workpiece. Depending on the direction of rotation, the workpiece will rotate and either loosen or tighten.

When force in direction 37 is applied to wrench 10, translation of bore 30 will again occur. Such translation causes rotor teeth 54 to disengage from bore teeth 34. In this disengaged position, the handle can rotate allowing the rotor teeth to index over the bore teeth such that the head rotates with respect to the rotor. Since rotor teeth 54 and bore teeth 34 are not interengaged, force will not be applied to the rotor or workpiece during indexing. Once the handle has been indexed about the rotor, force can again be applied in direction 35 to engage the rotor teeth with the bore teeth so that rotational force can be applied to the workpiece.

Optionally, when the teeth are disengaged, the use of speed ring 76 can be aid the user in the operation of wrench 10. While using wrench 10 to loosen a workpiece, once the user breaks the workpiece loose speed ring 76 can be gripped by hand and rotated counterclockwise to remove the workpiece without having to swing handle 12. Alternatively, if using wrench 10 to tighten a workpiece, once a workpiece is engaged by the wrench, the user may grip speed ring 76 by hand and rotate clockwise to tighten the workpiece to a point in which additional force is needed.

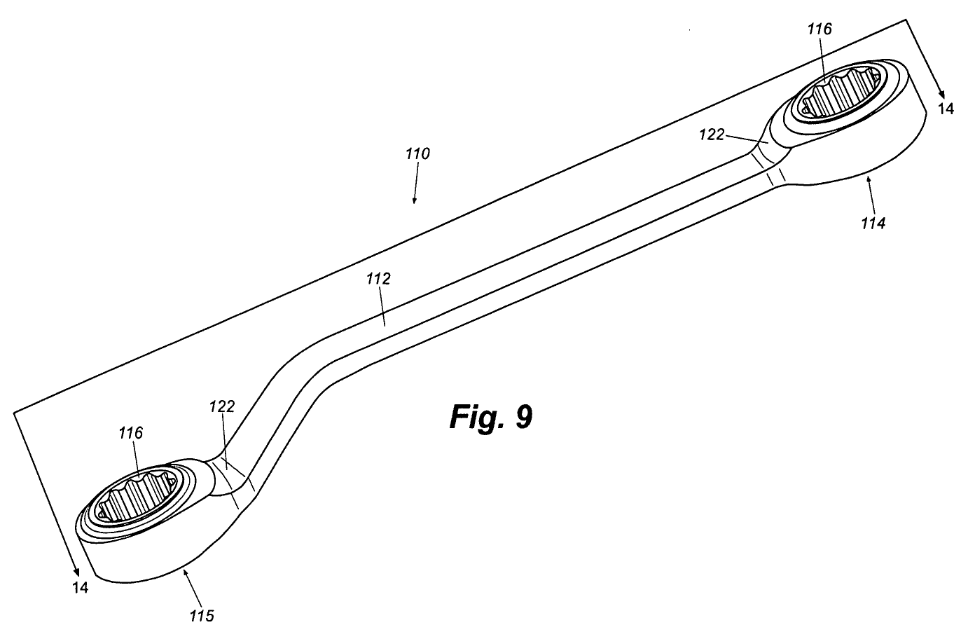

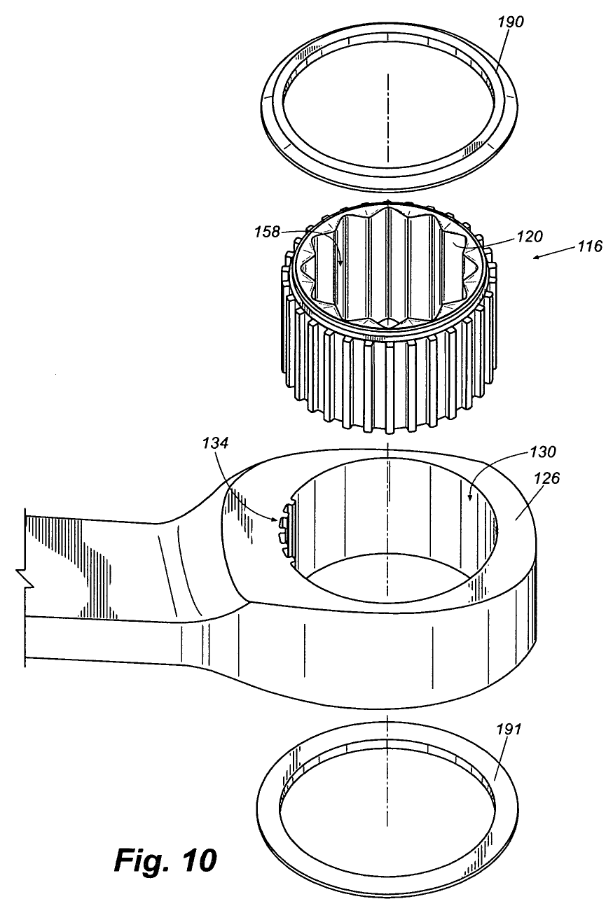

Referring to FIG. 9, a wrench 110 is shown constructed in accordance with another embodiment of the present invention. A handle 112 is integrally formed with a first head 114 and a second head 115. First head 114 and second head 115 are integrally formed with handle 112 by a neck 122. One skilled in the art will recognize that as an alternative to either first head 114 or second head 115, a bore, or other means of storing the wrench, could be provided. Alternatively, first head 114 or second head 115 could define an open end wrench or other tool. The operation and construction of wrench 110 is substantially similar to the embodiments previously discussed, the primary difference is the use of a rotor 116 (FIG. 10). In this embodiment, first head 114 and second head 115 each receive rotor 116.

Referring to FIG. 10, rotor 116 has a central cavity 158 that defines a twelve-point surface 120 for engaging a nut or other component to be torqued. It should be understood that cavity 158 may define any shaped opening such as a torx shape, square, hexagonal, etc. In other embodiments, central opening 158 can be configured to receive an open socket or other tool for performing a desired function. Still further embodiments are contemplated in which rotor 116 does not have a central opening, but instead carries a tang for receipt in a conventional socket.

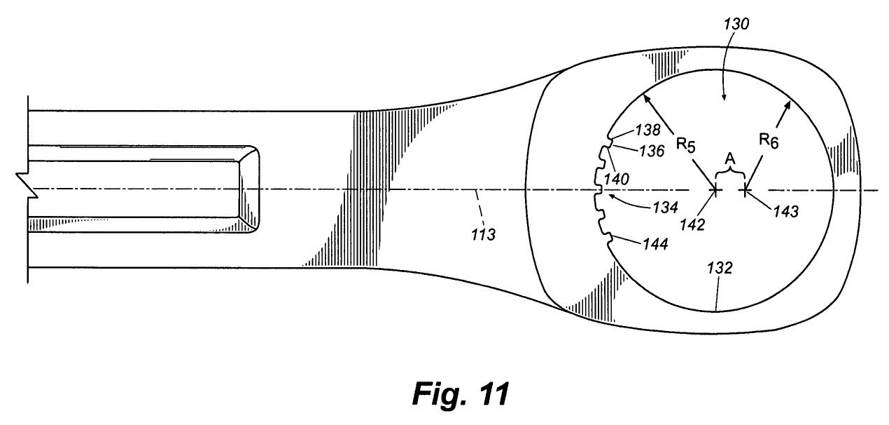

Referring to FIG. 11, a series of bore teeth 134 are formed on a portion of inner circumferential surface 132. With reference to a first bore tooth 136, each bore tooth has a first surface 138 and a second surface 140 that are substantially parallel to a plane that bisects first bore tooth 136 and intersects first arc center 142. In one preferred embodiment, first surface 38 and second surface 140 are substantially symmetric about a longitudinal center axis of first square-shaped bore tooth 136. In one preferred embodiment, bore teeth 134 each have a width of 0.041 inches with 0.066 inches of spacing between adjacent teeth. In some embodiments, first surface 138 and second surface 140 are symmetrical about a longitudinal center axis of the tooth yet angled slightly inward such that the base of the tooth is wider than the tip of the tooth thereby creating a trapezoid-shaped tooth. Bore teeth 134 are arranged sequentially on inner circumferential surface 132 from first tooth 136 to a last tooth 144. These teeth are of substantially equal height and shape and positioned on bore 130 such that bore teeth 134 are symmetric about longitudinal axis 113.

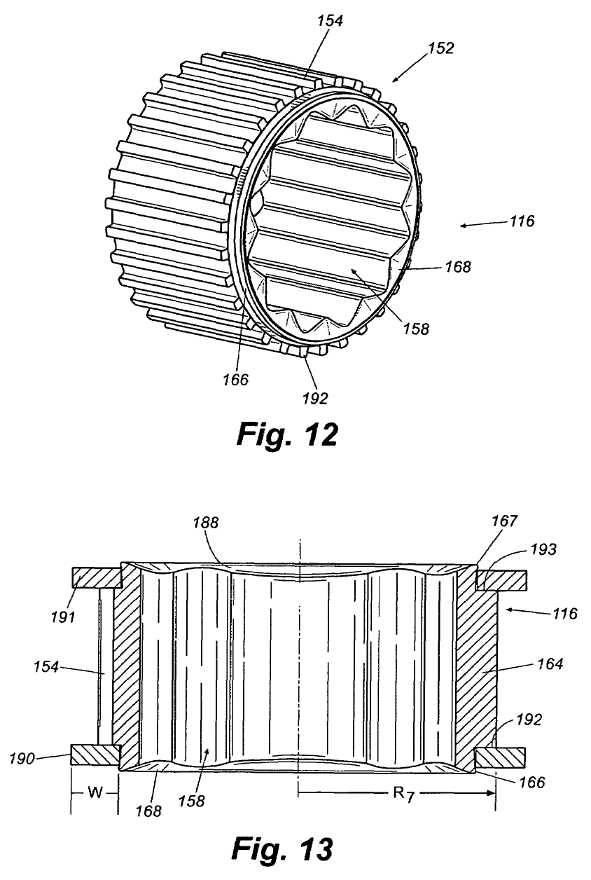

Referring also to FIGS. 12 and 13, rotor 116 is defined over a second radius R7, and has rotor teeth 154 that are axially aligned with the rotor's centerline on the rotor's outer circumferential surface. Rotor teeth 154 are substantially similar to the rotor teeth described previously and are configured to interengage with bore teeth 134 (FIG. 11).

Wall 164, between the root of teeth 154 and the inner diameter of rotor 116, is sized to maintain proper strength qualities for a desired application. First lip 166 is formed about a first outer edge of rotor 116 adjacent an edge 192 of rotor teeth 154. A second lip 167 is formed about a second outer edge of rotor 116 adjacent an edge 193 of rotor teeth 154. Tapered portions 168 and 188 facilitate positioning of first cavity 158 on a workpiece (not shown).

Referring to FIGS. 11 and 13, rotor 116 is received within head bore 130. As with the previous embodiments, bore radii R5 and R6 are substantially equal to radius R7. Since center of first arc 142 and center of second arc 143 are offset by distance A thereby creating an oval, rotor 116 can translate along longitudinal axis 113 by a distance substantially similar to distance A. Thus, there is sufficient free play between rotor 116 and inner circumferential surface 132 to allow the rotor teeth 154 to index over bore teeth 134 while not interengaged.

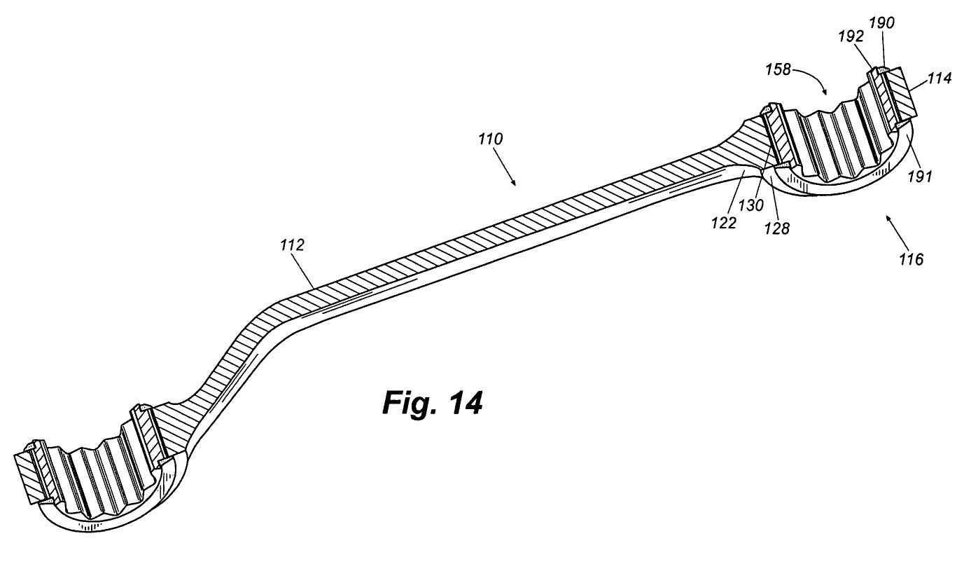

Referring now to FIGS. 12, 13 and 14, a first circular washer 190, having a width W, abuts rotor teeth end 192 and surrounds lip 166. A second circular washer 191, having a width W, abuts rotor teeth end 193 and surrounds lip 167. Washer width W is selected so that the washer substantially seals the interior of bore 130 from the outside, thereby preventing debris from interfering with the operation of the rotor and bore teeth. Once rotor 116 is inserted into head bore 130, and washer 190 is fitted about lip 166, a circular staking operation is performed upon lip 166 to secure washer 190 on rotor 116 and against top surface 126. Similarly, once washer 191 is fitted about lip 167, a circular staking operation is performed upon lip 167 to secure washer 191 on rotor 116 and bottom surface 128 so that the rotor is secured within head bore 130.

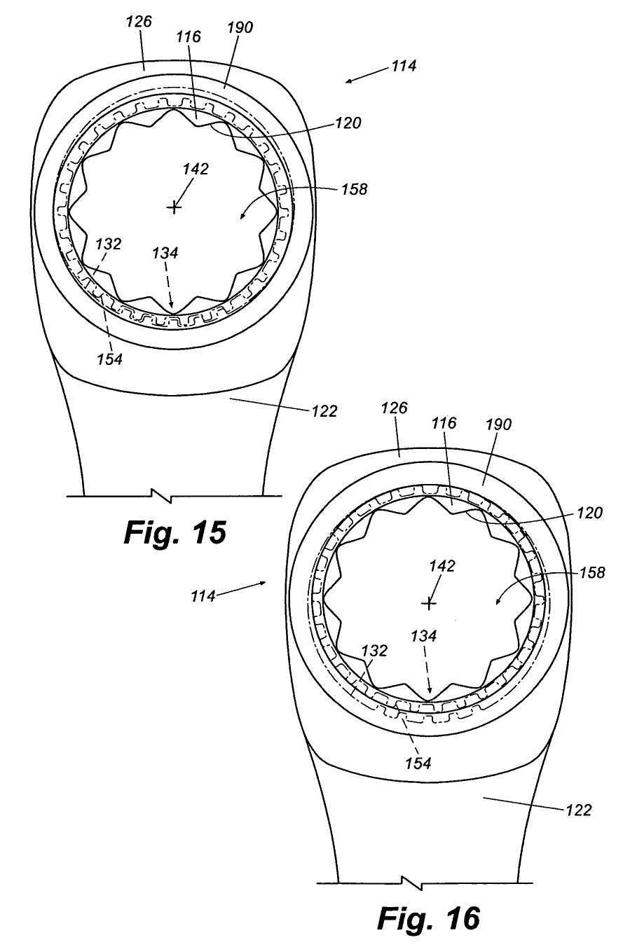

The operation of the wrench shown in FIGS. 9-16 is the same as the described for the wrench in FIGS. 1-8. Therefore the discussion is not repeated herein. While one or more preferred embodiments of the invention have been described above, it should be understood that any and all equivalent realizations of the present invention are included within the scope and spirit thereof. The embodiments depicted are presented by way of example and are not intended as limitations upon the present invention. Thus, those of ordinary skill in this art should understand that the present invention is not limited to these embodiments since modifications can be made. Therefore, it is contemplated that any and all such embodiments are included in the present invention as may fall within the scope and spirit thereof.

What is claimed:

1. A wrench, the wrench comprising:
a. a body having:
i. a top surface;
ii. a bottom surface;
iii. a head having a generally oval bore formed between the top surface and the bottom surface, the bore being defined over a first radius and a second radius that together define an inner circumferential surface;
b. a handle, having a longitudinal axis that intersects the head;
c. a generally cylindrical rotor at least partially received within the body bore, the generally cylindrical rotor having:
i. a first central portion defining a plurality of spaced-apart rotor teeth formed axially on an outer circumference thereof,
ii. a third radius defined from a-center of the rotor to a tip of the rotor teeth, and
iii. a first cavity formed axially in the first central portion, the cavity being configured to engage a workpiece;
d. at least one tooth formed on the inner circumferential surface of the bore that projects radially inward, the at least one bore tooth having a first surface having a first height, a second surface having a second height substantially equal to the first height and a horizontal flat top surface, where the first surface and the second surface are substantially symmetric about a center axis of the bore tooth, the plurality of spaced-apart rotor teeth being configured to engage the at least one bore tooth;
wherein
the at least one bore tooth is located symmetrically about the longitudinal axis,
in a first position, the bore tooth interengages the rotor teeth allowing torque to be transmitted from the handle to the workpiece in two opposite directions of rotation, and
in a second position, the body translates linearly with respect to the generally cylindrical rotor so that the tooth on the inner circumferential surface of the bore does not interengage the rotor teeth allowing free rotation of the handle about the rotor in two opposite directions of rotation without imparting torque to the workpiece.

2. The wrench in claim 1, the generally cylindrical rotor comprising a second portion defining,
a. a fourth radius defined from the rotor center to an outer circumference of the second portion, that is larger than both the first, second and third radii;
b. a second cavity formed axially in the second portion; and
c. a web separating the first and second rotor cavities;
wherein
the second cavity is configured to engage a workpiece, and
the second portion is adjacent to the wrench body top surface.

3. The wrench as in claim 2, wherein the rotor's second portion defines a flange adjacent the wrench head top surface, the flange having a frictional outer edge surface.

4. The wrench as in claim 3, wherein the frictional surface is a knurled surface.

5. The wrench as in claim 1, further comprising a magnet retained in the web such that the magnet is adjacent to the first and second cavities.

6. The wrench as in claim 5, the web further comprising a generally cylindrical central bore therethrough and wherein the magnet is generally cylindrical and press-fitted into the generally cylindrical central bore.

7. The wrench as in claim 1, wherein each bore tooth is a square-shaped tooth.

8. The wrench as in claim 1, wherein each bore tooth is a trapezoid-shaped tooth.

9. The wrench as in claim 1, the rotor further comprising a groove formed on an outer circumference thereon and a ring received in the groove.

10. The wrench as in claim 1, wherein the generally cylindrical rotor can translate along the longitudinal axis.

11. A wrench, the wrench comprising:
a. a body having:
i. a top surface;
ii. a bottom surface;
iii. a head having a generally oval bore formed between the top surface and the bottom surface, the bore generally being defined over a first radius and a second radius that together define an inner circumferential surface;
b. a handle, having longitudinal axis that intersects the head;
c. a generally cylindrical rotor at least partially received within the body bore, the generally cylindrical rotor having:
i. a first central portion defining a plurality of spaced-apart rotor teeth formed axially on an outer circumference thereof;
ii. a third radius defined from a center of the rotor to a tip of the rotor teeth; and
iii. a first cavity formed axially in the first central portion, the cavity being configured to engage a workpiece;
d. a second portion defining,
i. a fourth radius defined from the rotor center to an outer circumference of the second portion, that is larger than both the first, second and third radii;
ii. a second cavity formed axially in the second portion; and
iii. a web separating the first and second rotor cavities;
wherein
the second cavity is configured to engage a workpiece, and
the second portion is adjacent to the wrench body top surface;
e. at least one tooth formed on the inner circumferential surface of the bore that projects radially inward, the at least one bore tooth having a first surface having a first height and a second surface having a second height, that is substantially equal to the first height, and a horizontal planar top surface, where the first surface and the second surface are substantially symmetric about a center axis of the bore tooth, the plurality of spaced-apart rotor teeth being configured to engage the at least one bore tooth,
wherein
the at least one bore tooth is located symmetrically about the longitudinal axis,
in a first position, the bore tooth interengages the rotor teeth allowing torque to be transmitted from the handle to the workpiece in two opposite directions of rotation, and
in a second position, the body translates linearly with respect to the generally cylindrical rotor so that the tooth on the inner circumferential surface of the bore does not interengage the rotor teeth allowing free rotation of the handle about the rotor in the two opposite directions of rotation without imparting torque to the workpiece.

12. The wrench as in claim 11, wherein the rotor second portion defines a flange adjacent the wrench head top surface, the flange having an outer edge surface.

13. The wrench as in claim 12, wherein the flange outer edge surface is knurled.

14. The wrench as in claim 11, further comprising a plurality of square-shaped bore teeth.

15. The wrench as in claim 11, further comprising a plurality of trapezoid-shaped bore teeth.

16. A wrench, the wrench comprising:
a. a body having:
i. a top surface;
ii. a bottom surface;
iii. a head having a generally oval bore formed between the top surface and the bottom surface, the bore generally having a first radius and a second radius that together define an inner circumferential surface;
b. a handle, having a longitudinal axis that intersects the head;
c. a generally cylindrical rotor at least partially received within the body bore, the generally cylindrical rotor having:
i. a first central portion defining a plurality of spaced-apart rotor teeth formed axially on an outer circumference thereof;
ii. a third radius defined from a center of the rotor to a tip of the rotor teeth; and
iii. a first cavity formed axially in the first central portion, the cavity being configured to engage a workpiece;
d. a plurality of spaced-apart teeth formed on the inner circumferential surface of the bore that projects radially inward, the plurality of spaced-apart bore teeth each having a first surface having a first height, a second surface having a second height that is substantially equal to the first height and a generally planar top surface that is positioned substantially transverse to the handle axis where the first surface and the second surface are substantially symmetric about a center axis of the bore tooth, the plurality of spaced-apart rotor teeth being configured to engage the at least one bore tooth,
wherein
the plurality of spaced-apart teeth are located symmetrically about the longitudinal handle axis, and in a first position, the plurality of spaced-apart teeth interengages the rotor teeth allowing torque to be transmitted from the handle to the workpiece in two opposite directions of rotation, and
in a second position, the body translates linearly with respect to the generally cylindrical rotor along the handle axis so that the plurality of spaced-apart teeth does not interengage the rotor teeth allowing free rotation of the handle about the rotor in the two opposite directions of rotation without imparting torque to the workpiece.

17. The wrench as in claim 16, wherein the plurality of spaced-apart bore teeth are square-shaped teeth.

18. The wrench as in claim 16, wherein the plurality of spaced-apart bore teeth are trapezoid-shaped teeth.

19. The wrench as in claim 16, wherein the first radius is substantially equal to the second radius.
